(19) United States
(12) Patent Application Publication
(10) Pub. No.: US 2012/0158597 A1
(43) Pub. Date: Jun. 21, 2012

(54) Methods, Devices, and Computer Program Products for Providing Enhanced Customer Service

(76) Inventor: Dale Malik, Dunwoody, GA (US)

(21) Appl. No.: 12/971,787

(22) Filed: Dec. 17, 2010

(51) Int. Cl. G06Q 10/00

(52) U.S. Cl. 705/304

(57) ABSTRACT

Enhanced customer services is provided. Customer information regarding a product or service is received from a communication device. The received information is associated with a particular customer. Entry information indicating entry of the particular customer within an area associated with a retail premises is received, and a customer profile associated with the particular customer is retrieved. A customer service agent is selected for providing service to the particular customer based on the received customer information regarding the product or service and the retrieved customer profile. The customer information regarding the product or service and the retrieved customer profile are provided to a customer service agent terminal associated with the selected customer service agent for providing service to the particular customer.

### TECHNICAL FIELD

The present disclosure relates generally to telecommunications, and, more particularly, to providing enhanced customer service.

### BACKGROUND

Telephone and on-line-based customer service agents have great access to stored customer information when interacting with a customer. In the telephone/on-line-based customer service agent context, customer service agents are able to quickly access the customer history to assist them in providing customer service.

The telephone and on-line-based customer service interaction is generally fairly poor overall because it is not conducted face-to-face. Much of the potential information exchange is lost due to not the customer service agent not being able to see, in person, what the customer needs assistance with. This is especially true in the case of a retail sale situation, where the customer is inquiring about a specific product that both the customer service agent and the customer need to be able to see to adequately assess how to resolve the customer's issue. In theses cases, face-to-face customer service is preferable.

Face-to-face retail customer service interactions often suffer from the opposite problem of telephone and on-line-based customer service. The face-to-face retail customer service agent generally has no history of the previous customer visit, what the customer has purchased, what project the customer is working on, etc. A lot of time in the interaction may have to be spent by the customer providing the in-person customer service agent with information regarding the customer's previous service requests and products. This leads to frustration and results in an inefficient customer service interaction.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to one embodiment, a method for providing customer service includes receiving customer information regarding a product or service from a communication device. The received customer information is associated with a particular customer. The method further includes receiving entry information indicating entry of the particular customer within an area associated with a retail premises, retrieving a customer profile associated with the particular customer, and selecting a customer service agent associated with the retail premises for providing service to the particular customer based on the received customer information regarding the product or service and the retrieved customer profile. The customer information regarding the product or service and the retrieved customer profile are provided to a customer service agent terminal associated with the selected customer service agent for providing service to the particular customer.

According to another embodiment, a device for providing for providing customer service includes an interface for receiving customer information regarding a product or service from a communication device. The received information is associated with a particular customer. The interface also receives entry information indicating entry of the particular customer within an area associated with a retail premises. The device further includes a processor for receiving the customer information and the information indicating entry of the particular customer from the interface, retrieving a customer profile associated with the particular customer, selecting a customer service agent for providing service to the particular customer based on the received customer information regarding the product or service and the retrieved customer profile, and providing the customer information regarding the product or service and the retrieved customer profile to a customer service agent terminal associated with the selected customer service agent, via the interface, for providing service to the particular customer.

According to another embodiment, a non-transitory computer program product includes a storage medium upon which instructions are recorded that, when executed by a processor, perform a method for providing customer service. The method includes receiving customer information regarding a product or service from a communication device. The received information is associated with a particular customer. The method further includes receiving entry information indicating entry of the particular customer within an area associated with a retail premises, retrieving a customer profile associated with the particular customer, and selecting a customer service agent associated the retail premises for providing service to the particular customer based on the received customer information regarding the product or service and the retrieved customer profile. The customer information regarding the product or service and the retrieved customer profile are provided to a customer service agent terminal associated with the selected customer service agent for providing service to the particular customer.

### BRIEF DESCRIPTION OF THE DRAWINGS

FIG. 1 illustrates an exemplary system, including a communications network, in which the present disclosure can be implemented.

FIGS. 2A-2F illustrate exemplary screens which may be used by a user of a communication device for providing customer information for use by a customer service agent in providing customer service, according to exemplary embodiments.

FIG. 3 illustrates a block schematic diagram of a customer service management system according to an exemplary embodiment.

FIG. 4 illustrates an example of a screen that may be used by a customer service agent to interact with a customer, according to an exemplary embodiment.

FIG. 5 illustrates a method for providing enhanced customer service according to an exemplary embodiment.

### DETAILED DESCRIPTION

Detailed exemplary embodiments are disclosed herein. It must be understood that the embodiments described and illustrated are merely examples that may be embodied in various and alternative forms, and combinations thereof. As used herein, the word “exemplary” is used expansively to refer to embodiments that serve as examples or illustrations. The figures are not necessarily to scale, and some features may be exaggerated or minimized to show details of particular components. Specific structural and functional details disclosed herein are not to be interpreted as limiting.

According to exemplary embodiments, the best qualities of telephone/on-line-based customer service interactions are combined with those of the face-to-face retail service interactions, and the overall customer experience is enhanced. An automated customer service management system has the determine when a customer enters a retail premises, identify the customer, access the customer profile and receive information regarding a product or service in which the customer is interested, communicate with the customer while the customer, match the customer up with an appropriate customer service agent, and provide the customer service agent with the appropriate data in order to most efficiently assist the customer in making his or her store selections.

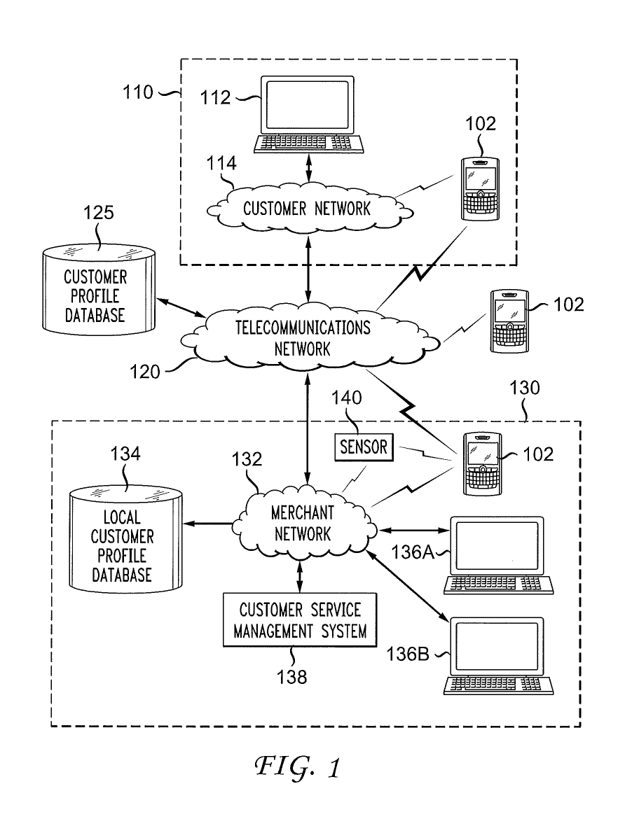

FIG. 1 illustrates an exemplary system, including a communication network, in which the present disclosure may be implemented. Customer information may be input at a communication device 112 of the customer or a mobile device 102 at the customer premises 110. Alternatively, customer information may be input via a communication device at any other suitable location.

The customer, as referred to herein, may include not only the actual customer but also an authorized representative of the customer. The customer information may include information regarding a product or service for which the customer desires service and information related to the product or service, e.g., a desired customer service date/time/location, as well as information identifying the customer. The communication device 112 may include, for example, a television, a personal computer, etc. The mobile device 102 may include a cellular telephone, a personal digital assistant, etc.

The communication device 112 and the mobile device 102 may communicate via a customer network 114 with a telecommunication network 120. The customer network 114 may include, for example, a Local Area Network (LAN) and/or various wired and wireless connection components. Additionally, the mobile device 102 may be used to input customer information via communication with the telecommunication network 120 while the customer is within the customer premises 110, as the customer (or another authorized user of the mobile device 102) moves outside of the customer premises 110, and/or at any other location from which the mobile device 102 is able to communicate with the telecommunications network 120.

The telecommunications network 120 may be implemented as one or more wireless networks that use exemplary telecommunications standards, such as Global System for Mobile communications (GSM) and Universal Mobile Telecommunications Systems (UMTS). It should be understood, however, that the embodiments may be implemented in wireless networks that use any existing or yet to be developed telecommunications technology. Some examples of other suitable telecommunication technologies include, but are not limited to, networks utilizing Time Division Multiple Access (TDMA), Frequency Division Multiple Access (FDMA), Wideband Code Division Multiple Access (WCDMA), Orthogonal Frequency Division Multiplexing (OFDM), Long Term Evolution (LTE), and various other 2G, 2.5G, 3G, 4G, and grater generation technologies. Examples of suitable data bearers include, but are not limited to General Packet Radio Service (GPRS), Enhanced Data Rates for Global Evolution (EDGE), the High-Speed Packet Access (HSDPA) protocol family, such as High-Speed Downlink Packet Access (HSDPA), Enhanced Uplink (EUL) or otherwise termed High-Speed Uplink Packet Access (HSUPA), Evolved HSPA (HSPA+) and various other current and future data bearers.

The telecommunications network 120, in turn, communicates with a merchant network 132 at a retail premises 130. The merchant network 132 may be implemented with, e.g., a corporate intranet. The merchant network 132 passes the customer information input via the communication device 112 and/or the mobile device 102 to a customer service management system 138. A customer profile may be retrieved from a local customer profile database 134 at the retail premises 130 and passed via the merchant network 132 to the customer service management system 138. Although shown as a separate element, the local customer profile database 134 may be integrated with the customer service management system 138. Alternatively, the customer profile may be stored at a database 125 hosted by a server and communicated to the customer service management system 138 via the merchant network 132 and the telecommunications network 120. As yet another alternative, at least a portion of the customer profile may be retrieved from and/or updated via the mobile device 102.

The customer profile may include, for example, information identifying the customer, a history of customer transactions indicating what purchases the customer has made, when purchases were made, how often the customer makes purchases, what was last purchased and when the last purchase was made, what the customer has returned and when, a history of customer service transactions, and other relevant information to help with assisting the customer.

Upon receipt of information indicating entry of the customer into the retail premises 130 (or entry into a predetermined area associated with the retail premises, e.g., a perimeter of several feet surrounding the retail premises 130), the customer may be automatically registered with the customer service management system 138. The customer profile may be retrieved upon validation of the registration by the customer. The customer may update the customer information via the mobile device 102 communicating with the merchant network 132 while the customer is within the retail premises 130. Once the customer is registered with the customer service management system 138, the customer need not validate again.

Once the customer is registered, the customer service management system 138 keeps track of customer transactions involving the customer, including the times and dates of entry of the customer into the retail premises 130, amounts of purchases/returns, customer service transactions, etc. The customer service management system 138 may facilitate automatic loading of a shopping cart, e.g., by keeping track of items scanned by the mobile device 102 and facilitate automatic check-out via the mobile device 102. The customer service management system 138 may generate an electronic receipt based on the customer transactions, which may be provided to the customer via communication with the mobile device 102 and/or the communication device 112.

Entry of the customer into the retail premises 130 may be detected by a sensor 140 detecting a signal emitted from the mobile device 102 as the customer returns to the retail premises 130. The sensor 140 may be part of a Femto system, including wireless access points interfaced with a wired or wireless broadband network. As part of a Femto system, the sensor 140 may be a wireless access point that detects mobile devices within a predetermined range. The predetermined range may be set so that it is roughly the size of the retail premises 130. For further details of a Femto system, reference is made to copending, commonly assigned U.S. Published Patent Application No. 2010/0159945, herein incorporated by referenced.

Alternatively, the sensor 140 may be implemented with a transceiver for emitting signals that may be reflected by the mobile communication device, a biometric sensor, or any other suitable device for detecting entry of the mobile communication device 102 and/or the customer into the retail premises 130. As yet another alternative, the customer may indicate entry into the retail premises 130, e.g., by calling a customer service telephone number associated with the retail premises 130.

Upon detection of entry of the customer into the retail premises 130 (or within an area associated with the retail premises 130), the customer service management system 138 may add information identifying the customer to a customer service queue. The customer service management system 138 may keep track of how long the customer is in the queue each time the customer is queued, such that a customer may be escalated for customer service, e.g., if the customer previously had a long wait time. Queuing by the customer service management system 138 may be based on the customer profile, such that high priority customers, e.g., frequent buyer customers or escalated customers, are given a better place in line.

According to an exemplary embodiment, if the customer leaves the retail premises 130 before customer service is provided, exit of the customer may be detected in a manner similar to detection of entry of the customer. When the customer exits, the customer's place may be retained in the queue for a predetermined amount of time. When the customer returns to the retail premises 130, entry of the customer may be detected, and the customer may be returned to his or her place in the customer service queue.

The customer may be contacted via the mobile device 102 when he or she has reached or is near the front of the customer service queue, whether or not the customer is within the retail premises 130. The contact may depend on how long the customer has been in the queue and whether or not the customer has responded to an indication that he or she has reached or is near the front of the queue. For example, if the customer has been contacted via, e.g., a text message sent to the mobile device, that he or she is up next in the queue, but the customer does not respond or appear for customer service after several minutes, the customer may be contacted via a phone call to the mobile device 102.

The customer service management system 138 selects a customer service agent associated with the retail premises for fulfilling a request of a customer based on the customer profile and the requested product or service and passes the information regarding the customer and the requested product service to the appropriate customer service agent terminal 136A, 136B. The customer service agent may be selected based on, e.g., who the customer has scheduled service with, expertise of the customer service agents, priority of the customer, etc.

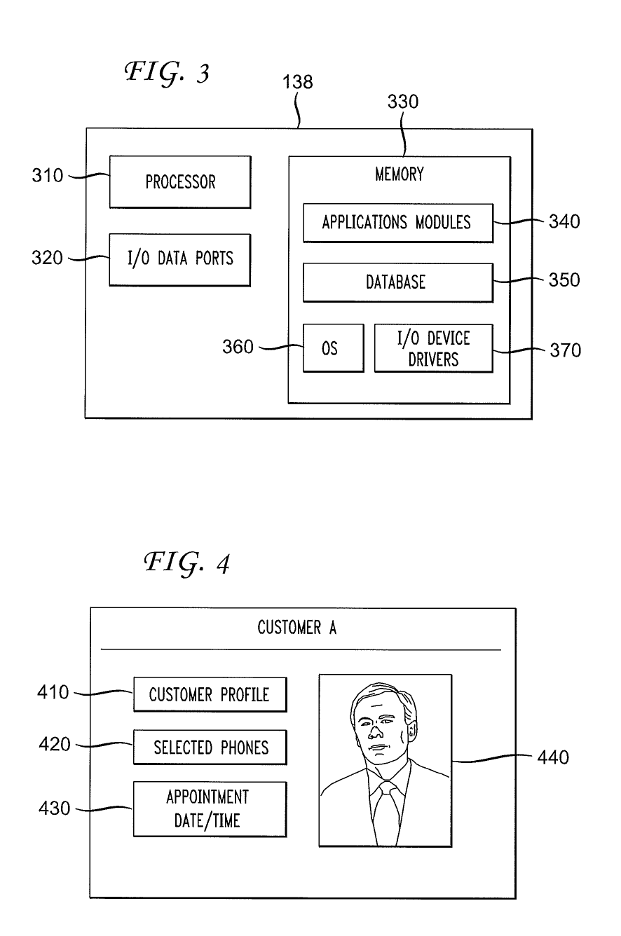

The customer service agent terminals 136A and 136B may be implemented with, e.g., personal computing devices or other devices capable of communicating with the merchant network 132 and displaying information for assisting in providing customer service. The customer service management system 138 may be implemented with a device such as that shown in detail in FIG. 3.

Upon completion of customer service, the customer may be provided with a receipt of transactions and other information related to the customer service experience by the customer service management system 138. The receipt may be delivered electronically to the mobile device 102 and/or to the user device 112 via the merchant network 132 and the telecommunications network 120.

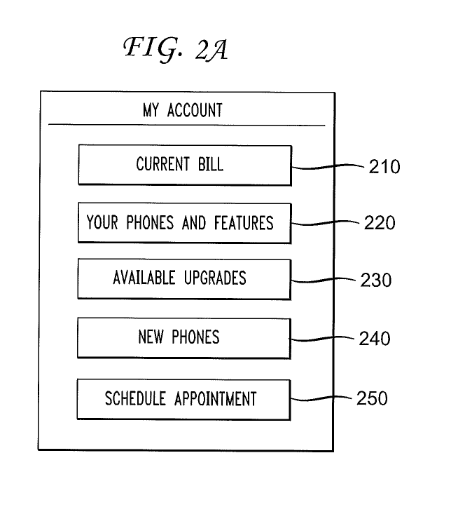

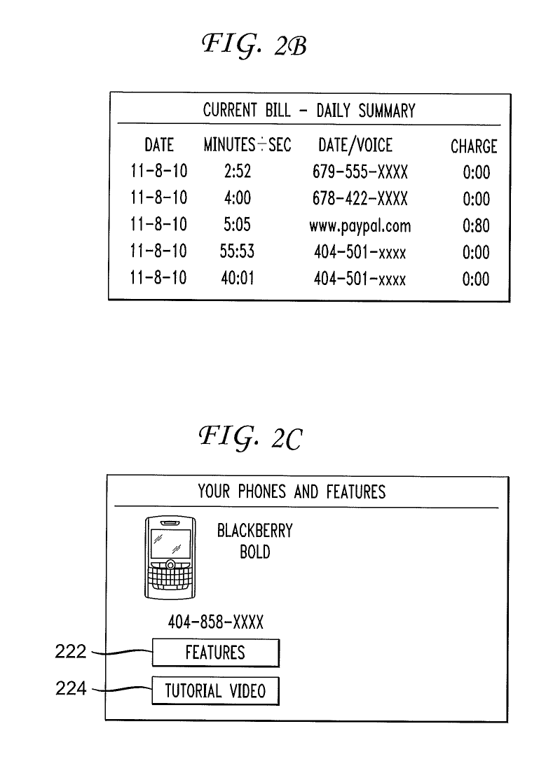

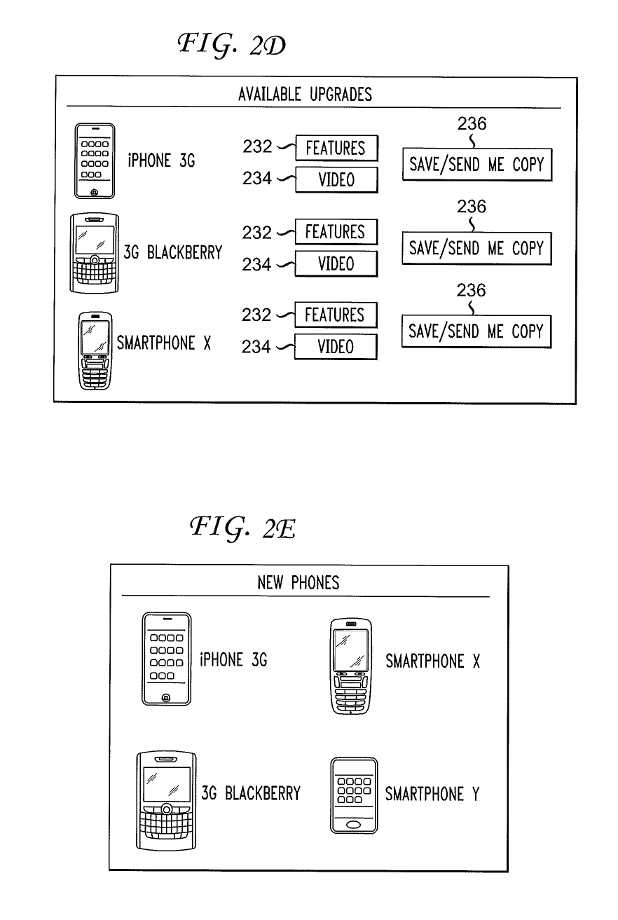

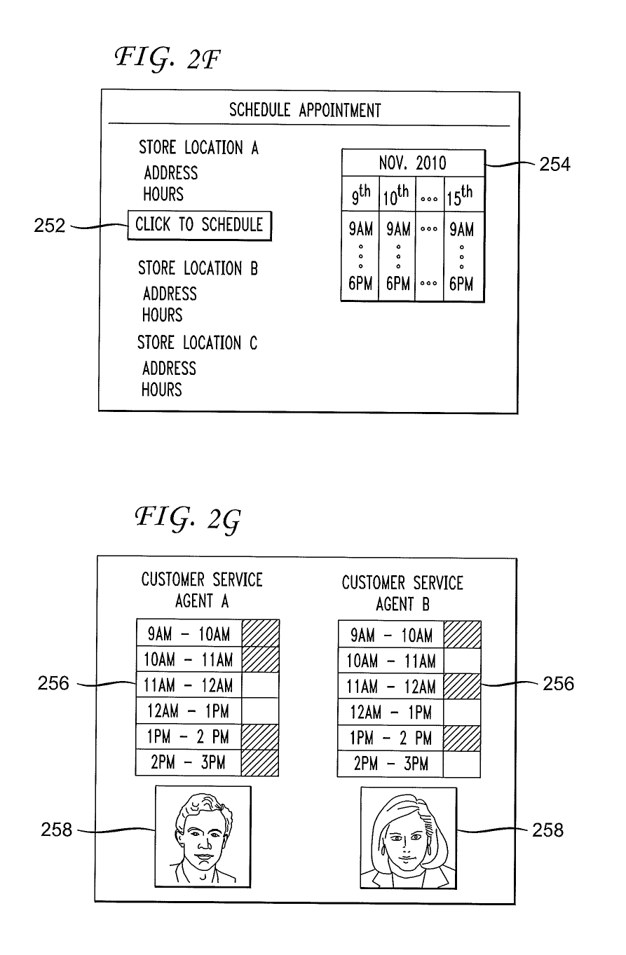

To illustrate various aspects of the present disclosure, consider a scenario in which a customer desires to make a customer service appointment to upgrade a telephone. This scenario may be understood with reference to FIGS. 2A-2F and FIG. 4. FIGS. 2A-2F illustrate examples of options that may be displayed via a screen to a customer on the communication device 112, the mobile device 102, or another device.

Referring to FIG. 2A, a customer may be shown a summary of an account, e.g., by selecting “My Account” on a menu. Options presented to the customer may include Current Bill 210, Your Phones and Features 220, Available Upgrades 230, New Phones 240, and Schedule Appointment 250. According to an exemplary embodiment, the data associated with the customer's account may be fetched from an account server via, e.g., the customer network 114 and the telecommunications network 120, and may be stored locally, e.g., within the communication device 112.

According to an exemplary embodiment, selection of the Current Bill option 210 causes a summary page with voice and data charges to be displayed, as illustrated in FIG. 2B. Selection of the Your Phones and Features option 220 causes an image and a name of the customer's device to be displayed, along with a Features option 222 and a Tutorial Video option 224, as illustrated in FIG. 2C. Additionally, other information, such as a telephone number, may be displayed.

Selection of the Available Upgrades option 230 causes a screen showing phones to which the customer is eligible to upgrade. As shown in FIG. 2D, a Features option 232 and a Video option 234 may be presented, offering detailed information regarding the available upgrades. Also, the customer may select a Save/Send Me Copy option 238, which may cause an account server to send information regarding available and/or selected upgrades to any device designated by the customer, such as the communication device 112, the mobile device 102 and/or the customer service management system 138. The Available Upgrade screen may also show information identifying accounts that are near or currently available for an upgrade.

Selection of the New Phones option 240 shows images and summaries of the latest phones, as illustrated in FIG. 2E. Selection of the Schedule Appointment option 250 causes retail stores near a particular location, e.g., stores near the customer's billing address, to be displayed, as illustrated in FIG. 2F. Other information, e.g., store hours, address, and telephone numbers, may also be displayed for each store. A Click to Schedule option 252 may be selected for stores offering on-line appointment scheduling. For those stores not offering on-line appointment scheduling, the customer may call the phone numbers of the stores to schedule appointments. After selecting the Click to Schedule option 252, a calendar 254 may be presented on the Schedule Appointment screen, showing dates and times from which the customer may schedule an appointment.

Upon selection of particular date and time (or time range), a screen showing customer service agents that are available at the selected data and time is displayed, as illustrated in FIG. 2G. Information displayed may include the available times 256 for scheduling appointments with each of the customer service agents and images of the customer service agents. Also, the customer service agent's expertise with a particular phone may be displayed, along with recommendations of phones by the customer service agents and/or an indication of the phones that the customer service agents currently use.

The customer may choose a time for an appointment with a particular customer service agent from the available times for that agent. Once the date/time for the appointment is selected, the customer may confirm the appointments and indicate the phone(s) that he or she is interested in. Upon confirmation of the selection, e.g., by an account server, a text message may be sent to the mobile device 102 with information regarding the appointment, the phones the customer is interested in, and the customer service agent with which the appointment is scheduled. When this screen is re-entered, the currently scheduled appointment may be shown on the screen with the menu of options for changing the appointment time/date, etc.

The appointment information is transmitted to the customer service management system 138 via, e.g., the customer network 114, the telecommunications network 120, and the merchant network 132. The customer service management system 138 may match the appointment up with the customer service agent within the premises 130 and transmit the appointment information to the customer service agent terminal 136A, 136B. An appointment alert may be displayed on the customer service agent terminal 136A, 136B, along with other information regarding the customer, as described with reference to FIG. 4 below.

FIG. 3 is a block diagram of a device for providing customers service information, e.g., the customer service management device 138, according to an exemplary embodiment. The device 300 includes a processor 310 that receives information, such as customer information, the customer profile, and information indicating entry of the customer into the retail premises, via I/O Data Ports 420. The I/O Data Ports 320 can be implemented with, e.g., an interface including an antenna or other suitable type of transceiver through which data and signals may be transmitted and received. It should be appreciated that the I/O Data Ports 320 can be used for communications between the customer service management system 138 and the merchant network 132.

The processor 310 communicates with the memory 330 via, e.g., an address/data bus. The processor 310 can be any commercially available or customer microprocessor. The memory is 330 is representative of the overall hierarchy of memory devices containing the software and data used to implement the functionality of the device 300. The memory 330 can include but is not limited to the following types of devices: processor registers, processor cache, RAM, ROM, PROM, EPROM, EEPROM, flash memory, SRAMD, DRAM other volatile memory forms, and non-volatile, semi-permanent or permanent memory types; for example, tape-based media, optical media, solid state media, hard disks, combinations thereof, and the like.

As shown in FIG. 3, the memory 330 may include several categories of software and data used in the device 300, including applications 340, a database 350, an operating system (OS) 360, and the input/output (I/O) device drivers 370. As will be appreciated by those skilled in the art, the OS 360 may be any operating system for use with a data processing system. The I/O device drivers 370 may include various routines accessed through the OS 360 by the applications 340 to communicate with devices, and certain memory components. The applications 340 can be stored in the memory 330 and/or in a firmware (not shown) as executable instructions, and can be executed by the processor 310. The applications 340 include various programs that, when executed by the processor 310, implement the various features of the device 300, including selecting a customer service agent, keeping track of customer transactions, queuing a customer, etc., to apply to data stored in the database 350, along with data, such as entry information, customer information regarding a product or service and a customer profile, received via the I/O data ports 320. The database 350 represents the static and dynamic data used by the applications 340, the OS 360, the I/O device drivers 370 and other software programs that may reside in the memory. The database 350 may include, for example, information regarding the expertise of the customer service agents, customer service queue information, etc.

While the memory 330 is illustrated as residing proximate the processor 310, it should be understood that at least a portion of the memory 330 can be a remotely accessed storage system, for example, a server on a communication network, a remote hard disk drive, a removable storage medium, combinations thereof, and the like. Thus, any of the data, applications, and/or software described above can be stored within the memory 330 and/or accessed via network connections to other data processing systems (not shown) that may include a local area network (LAN), a metropolitan area network (MAN), or a wide area network (WAN), for example.

It should be understood that FIG. 3 and the description above are intended to provide a brief, general description of a suitable environment in which the various aspects of some embodiments of the present disclosure can be implemented. While the description refers to computer-readable instructions, the present disclosure also can be implemented in combination with other program modules and/or as a combination of hardware and software in addition to, or in stead of, computer readable instructions. The term “application,” or variants thereof, is used expansively herein to include routines, program modules, programs, components, data structures, algorithms, and the like. Applications can be implemented on various system configurations, including single-processor or multiprocessor systems, minicomputers, mainframe computers, personal computers, hand-held computing devices, microprocessor-based, programmable consumer electronics, combinations thereof, and the like.

Upon matching the customer information and customer profile with a customer service agent, the customer service management system 138 transmits this information to the customer service agent terminal, e.g., terminal 136. A screen is presented to the customer service agent, including information associated with the customer, as shown in FIG. 4. FIG. 4 illustrates an example of a screen that may be used by a customer service agent to interact with a customer or a customer representative, according to an exemplary embodiment.

Upon receipt of customer information indicating a scheduled appointment via the customer service agent terminal, the customer service agent may receive an alert and acknowledge the appointment via the customer service terminal. As shown in FIG. 4, the screen presented to the customer service agent may include a Customer Profile 410, Selected Phones, 420, an Appointment Date/Time 430, and an image of the customer 440 (which may be taken by the customer and sent as part of the customer information to the customer service agent terminal via the customer service management system 138). The customer service agent may review the customer's account by selecting the customer profile option 410 and may view the products or services, e.g., phones pre-selected by the customer by selecting the Selected Phone option 420. The customer service agent may select the Appointment Date/Time option 430 to view the scheduled appointment date/time and to enter a message that will transmitted back to the customer confirming the appointment and offering additional information that may be useful for the appointment. The information from the customer service agent may be displayed on the communication device 112, the mobile device 102, or any other device associated with the customer.

The customer's entry may be detected or indicated as described above. If the customer arrives early for his or her appointment, the customer's entry is detected, and an alert may automatically be posted to the customer service agent's terminal so the customer service agent can look for the customer and/or send them a welcome message. The customer service agent can pull up the customer profile and customer information, along with information regarding the products or services, e.g., pre-selected phones, which the customer is interested in, on the customer service agent terminal.

Referring again to the illustrative example of a phone upgrade, when the customer decides to purchase and upgrade to a new phone, the customer service agent completes the upgrade and marks the phone selected on the customer service agent terminal. This may cause a text message to be sent to the customer's new phone with some basic information and lets the customer know they can receive additional helpful information on, e.g., the communication device 112.

Information regarding the customer service transaction may be transmitted to the communication device 112 and/or the mobile communication device 102. Thus, for example, once the customer arrives back at the customer premises 110 and returns to the My Account menu, information regarding the new phone may be displayed highlighted under “Current Phones and Features”. By selecting this option, the customer may be provided with, for example, demonstrations on a newly purchased phone and other information regarding available applications for the phone.

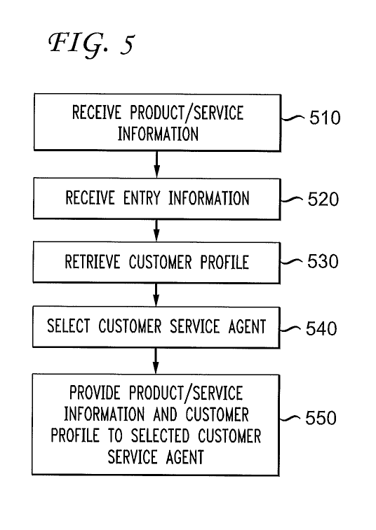

FIG. 5 illustrates an exemplary method for providing customer service according to exemplary embodiments. At step 510, customer information regarding a product or service is received at the customer service management system 138. This information may include information input by a customer, e.g., at the customer premises 110 or at any other location. At step 520, information indicating entry of a customer into the retail premises 130 (or within an area associated with the retail premises) is received by the customer service management system 138. This information may be detected by one or more sensors 140 within the retail premises 130 and/or indicated by the mobile device 102. At step 530, the customer profile is retrieved by the customer management service management system 138. The customer profile may be retrieved from the local customer profile database 134 and/or from a customer profile database 125 hosted by a server that also stores the customer profile for various other merchants. At step 540, the customer service management system 138 selects the customer service agent for fulfilling the customer's request. At step 550, the customer service management system 138 provides the customer information regarding the product or service and the customer profile to the selected customer service agent at the customer service agent terminal, e.g., 136A or 136B.

The law does not require and it is economically prohibitive to illustrate and teach every possible embodiment of the present claims. Hence, the above-described embodiments are merely exemplary illustrations of implementations set forth for a clear understanding of the principles of the invention. Variations, modifications, and combinations may be made to the above-described embodiments without departing from the scope of the claims. All such variations, modifications, and combinations are included herein by the scope of this disclosure and the following claims.

What is claimed is:

1. A method for providing customer service, comprising:
receiving customer information regarding a product or service from a communication device, wherein the received customer information is associated with a particular customer;
receiving entry information indicating entry of the particular customer within an area associated with a retail premises;
retrieving a customer profile associated with the particular customer;
selecting a customer service agent associated with the retail premises for providing service to the particular customer based on the received customer information regarding the product or service and the retrieved customer profile; and
providing the customer information regarding the product or service and the retrieved customer profile to a customer service agent terminal associated with the selected customer service agent for providing service to the particular customer.

2. The method of claim 1, receiving information indicating entry of the customer within the area associated with the retail premises comprises detecting entry of a mobile communication device of the customer into the retail premises and wherein the selected customer service agent provides customer service to the particular customer within the retail premises.

3. The method of claim 1, wherein the customer profile is retrieved from at least one of a customer profile database local to the retail premises and a customer profile database remote to the retail premises.

4. The method of claim 1, wherein the communication device from which the customer information regarding the product or service is received is remote to the retail premises.

5. The method of claim 1, wherein the communication device from which the customer information regarding the product or service is received is a mobile communication device of the customer.

6. The method of claim 1, wherein the customer service agent is selected based on at least one of a request of the customer for service from a particular customer service agent and qualifications of the customer service agent.

7. The method of claim 1, further comprising adding information identifying the customer to a queue for customer service.

8. A device for providing customer service, comprising:
an interface for receiving customer information regarding a product or service from a communication device, wherein the received information is associated with a particular customer, and receiving entry information indicating entry of the particular customer within an area associated with a retail premises; and
a processor for receiving the customer information and the information indicating entry of the particular customer from the interface, retrieving a customer profile associated with the particular customer, selecting a customer service agent associated with the retail premises for providing in-person service to the particular customer based on the received customer information regarding the product or service and the retrieved customer profile, and providing the customer information regarding the product or service and the retrieved customer profile to a customer service agent terminal associated with the selected customer service agent, via the interface, for providing in-person service to the particular customer.

9. The device of claim 8, wherein the received information indicating entry of the customer within the area associated with the retail premises includes information indicating detection of entry of a mobile communication device of the customer into the retail premises and wherein the selected customer service agent provides customer service to the particular customer within the retail premises.

10. The device of claim 8, wherein the customer profile is retrieved from at least one of a customer profile database local to the retail premises and a customer profile database remote to the retail premises.

11. The device of claim 8, wherein the communication device from which the customer information regarding the product or service is received is remote to the retail premises.

12. The device of claim 8, wherein the communication device from which the customer information regarding the product or service is received is a mobile communication device of the customer.

13. The device of claim 8, wherein the customer service agent is selected based on at least one of a request of the customer for service from a particular customer service agent and qualifications of the customer service agent.

14. The device of claim 8, wherein the processor adds information identifying the customer to a queue for customer service.

15. A non-transitory computer program product including a storage medium upon which instructions are recorded that, when executed by a processor perform a method for providing customer service, the method comprising:
receiving customer information regarding a product or service from a communication device, wherein the received information is associated with a particular customer;
receiving entry information indicating entry of the particular customer within an area associated with a retail premises;
retrieving a customer profile associated with the particular customer;
selecting a customer service agent associated with the retail premises for providing in-person service to the particular customer based on the received customer information regarding the product or service and the retrieved customer profile; and
providing the customer information regarding the product or service and the retrieved customer profile to a customer service agent terminal associated with the selected customer service agent for providing service to the particular customer.

16. The non-transitory computer program product of claim 15, wherein receiving information indicating entry of the customer within the area associated with the retail premises comprises detecting entry of a mobile communication device of the customer into the retail premises and wherein the selected customer service agent provides customer service to the particular customer within the retail premises.

17. The non-transitory computer program product of claim 15, wherein the communication device from which the customer information regarding the product or service is received is remote to the retail premises.

18. The non-transitory computer program product of claim 15, wherein the communication device from which the customer information regarding the product or service is received is a mobile communication device of the customer.

19. The non-transitory computer program product of claim 15, wherein the customer service agent is selected based on at least one of a request of the customer for service from a particular customer service agent and qualifications of the customer service agent.

20. The non-transitory computer program product of claim 15, wherein the method further comprises adding information identifying the customer to a queue for customer service
